(19) United States
(12) Patent Application Publication
(10) Pub. No.: US 2006/0216481 A1
(43) Pub. Date: Sep. 28, 2006

(54) Method for producing compressed wood article, and compressed wood articles

(75) Inventor: Tatsuya Suzuki, Tokyo (JP)

Correspondence Address: HOGAN & HARTSON L.L.P., 500 S. GRAND AVENUE, SUITE 1900, LOS ANGELES, CA, 90071-2611, US

(73) Assignee: OLYMPUS CORPORATION

(21) Appl. No.: 11/317,990

(22) Filed: Dec. 22, 2005

Related U.S. Application Data
(63) Continuation of application No. PCT/JP05/17563, filed on Sep. 16, 2005.

(30) Foreign Application Priority Data
Mar. 25, 2005 (JP) P2005-088121

(51) Int. Cl. B29C 53/04; B32B 1/00

(52) U.S. Cl. 428/174; 264/320; 264/339; 428/151

(57) ABSTRACT

This method for producing a compressed wood article, comprises the step of cutting out, from a raw wood, a plate-shaped blank member having a curved surface intersecting its thickness direction, and the step of compressing said blank member using molding dies.

### PRIORITY CLAIM

This application is continuation application of a PCT Application No. PCT/JP2005/017563, filed on Sep. 16, 2005, entitled “METHOD FOR PRODUCING COMPRESSED WOOD ARTICLE, AND COMPRESSED WOOD ARTICLES” whose priority is claimed on Japanese Patent Application No. 2005-88121, filed on Mar. 25, 2005. The content of both the PCT Application and Japanese Application is incorporated herein by reference.

### BACKGROUND OF THE INVENTION

1. Field of the Invention

The present invention relates to a method for producing a compressed wood article, and a compressed wood article. For example, the invention relates to a method for producing a compressed wood article in which the grain lines thereof may be readily varied even in a case of a small-sized compressed wood article, and to a compressed wood article.

2. Description of Related Art

Conventionally, it has been proposed that wooden structures having various shapes such as, for example, a plate material, a box, a container, a covering member, etc., are to be manufactured using a compressed wood article formed by molding dies. In such a wooden structure, a grain pattern consisting of a number of grain lines is formed by annual rings of the wood exposed on the cut surface, thus providing the wooden structure with an excellent appearance.

The compressed wood article is manufactured by compressing a blank member cut out from wood, using molding dies. For cutting out a blank member, there are two methods, one of which is to cut out a blank member having a three-dimensional shape, in which an allowance for compression is left in the thickness direction thereof, following the three-dimensional shape of the molding dies, and the other of which is to cut out a flat plate-shaped blank member.

For example, Japanese Unexamined Patent Application, First Publication No. H08-25301 and Japanese Unexamined Patent Application, First Publication No. H11-77619 disclose a method for processing a wooden material or a woody material, in which a wooden material is compressed in a direction orthogonal to the wood fiber direction, a plate material with cross grains is cut out in the direction along the wood fiber direction as a blank member, and the blank member is three-dimensionally formed using molding dies.

### SUMMARY OF THE INVENTION

A method for producing a compressed wood article according to the invention, comprises the steps of: cutting out, from a raw wood, a plate-shaped blank member having a curved surface intersecting its thickness direction, in which the curved surface has a portion whose normal lines are not orthogonal to the direction in which the wood fibers extend; and compressing the blank member using molding dies.

In the method for producing a compressed wood article according to the invention, it is preferable that the curvature of the portion, which is included in the curved surface, differs from a curvature of the die surface of the molding dies corresponding to the portion.

A compressed wood article of the invention is a compressed wood article that is cut out from a raw wood and has grain lines exposed on its flat or curved surface. The wood article is cut out from a raw wood into such a shape that has a curvature different from that of the surface and has a curved surface including a portion where the normal lines are not orthogonal to the direction in which the wood fibers extend. The wood article is compressed, whereby the curved surface is formed to form the surface, and the grain lines formed on the curved surface are exposed on the surface.

### BRIEF DESCRIPTION OF THE DRAWINGS

FIG. 1 is a perspective view schematically depicting the shape of a compressed wood article according to the invention.

FIG. 2 is a sectional view taken along the line A-A shown in FIG. 1, schematically depicting the shape of a compressed wood article according to the invention.

FIG. 3 is a perspective view of a base material which is starting material for a compressed wood article.

FIG. 4 is a perspective view depicting a blank member cut out from the base material shown in FIG. 3.

FIG. 5 is a plan view depicting the blank member shown in FIG. 4 from its front side.

FIG. 6 is a plan view depicting the blank member shown in FIG. 4 from its rear side.

FIG. 7 is a sectional view depicting a state where the blank member is set between molding dies in a compressing step of the blank member shown in FIG. 4.

FIG. 8 is a sectional view depicting a state where the blank member is compressed by molding dies in a compressing step of the blank member shown in FIG. 4.

FIG. 9 is a sectional view depicting a compressed wood article taken out from the molding dies in a compressing step of the blank member shown in FIG. 4.

FIG. 10 is a sectional view depicting a blank member for a first modification of a compressed wood article according to the invention when being observed from the direction of wood fibers.

FIG. 11 is a sectional view depicting a blank member for the first modification of the compressed wood article according to the invention when being observed from the direction orthogonal to the wood fibers.

FIG. 12 is a plan view depicting a blank member for the first modification of the compressed wood article according to the invention when being observed from above.

FIG. 13 is a sectional view depicting a blank member for a second modification of a compressed wood article according to the invention when being observed from the direction of wood fibers.

### DETAILED DESCRIPTION OF THE INVENTION

A description is given of embodiments of the invention with reference to the drawings. Also, in all the accompanying drawings, the same parts are given the same reference numerals, and an overlapping description thereof is omitted even in different embodiments.

First, a compressed wood article according to the invention will be described below.

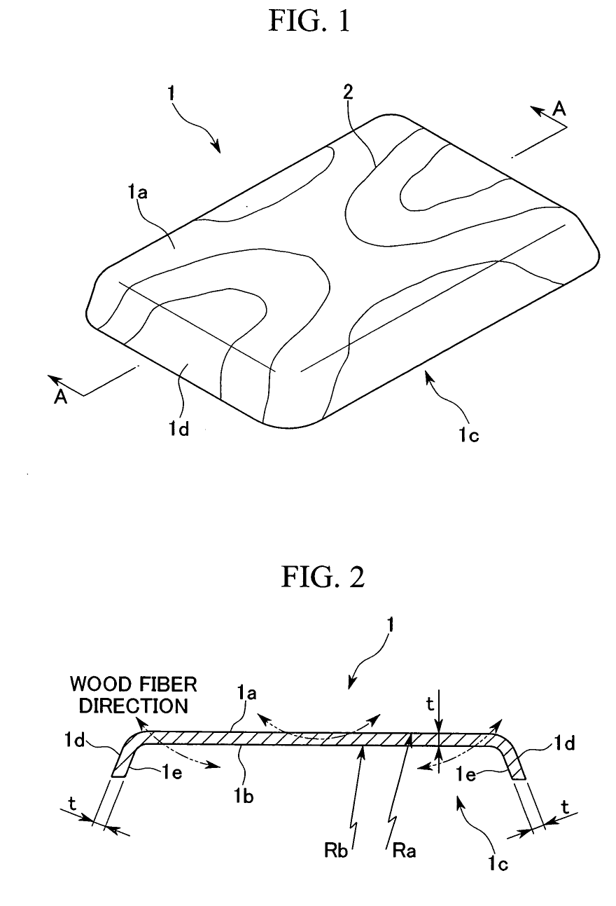

FIG. 1 is a perspective view schematically depicting the shape of a compressed wood article according to the embodiment of the invention. FIG. 2 is a sectional view taken along the line A-A shown in FIG. 1.

The compressed wood article 1 according to this embodiment is formed so as to have a three-dimensional shape by compression using molding dies. As depicted in FIG. 1 and FIG. 2, the compressed wood article 1 is a box-like member which has a substantially rectangular planer image and has side portions at the surrounding of its bottom and an opening 1c on one side thereof. Although the thickness of each portion may differ from each other according to the location of the position, the compressed wood article 1 according to the embodiment has an almost uniform thickness t.

The compressed wood article 1 may be utilized as, for example, a box, a container, a covering member, etc.

Since each portion of the compressed wood article 1 is formed three-dimensionally, a curved surface, having an arbitrary curvature, on which the shape of the die surface is transferred is formed on the surface of the compressed wood article 1. In the case of the embodiment, a radius of curvature Rₐ of an outer surface 1a of the bottom portion and a radius of curvature R_{b} of an inner surface 1b of the bottom portion are, respectively, infinite. That is, both the outer surface 1a of the bottom portion and the inner surface 1b of the bottom portion are made into flat planes.

As depicted in FIG. 1, grain lines 2 are exposed on the outer surface 1a of the bottom portion and an outer surface 1d of the side portion. The grain lines 2 are a group of U-shaped curved lines which open toward respective four sides of the opening 1c, and form an intricate grain pattern excellent in design. Both ends of the respective grain lines 2 extend to the respective sides of the opening 1c. Also, although not illustrated, similar grain lines 2 are exposed on the inner surface 1b of the bottom portion and the inner surfaces 1e of the side portions, forming an intricate grain pattern excellent in design.

The grain pattern differs from the grain pattern of wood cut out so as to form a curved surface having the same curvature as that of the outer surface 1a of the bottom portion or the inner surface 1b of the bottom portion. For example, in a case of a compressed wood article formed from a blank member cut out so that the outer surface 1a of the bottom portion and the inner surface 1b of the bottom portion present a flat plane, if the outer surface 1a of the bottom portion and the inner surface 1b of the bottom portion are cut out in parallel to the wood fiber direction, a cut out surface of the wood fibers is not generated, and if they are cut out in the direction orthogonal to the wood fiber direction, a cut out surface making an almost fixed angle with respect to the wood fibers is formed. On the other hand, in the compressed wood article 1 according to the embodiment, the wood fiber direction is curved as depicted by virtual lines in FIG. 2, and the angle made by the wood fibers with the outer surface 1a of the bottom portion and the inner surface 1b of the bottom portion changes along the direction of a line A-A shown in FIG. 1.

Subsequently, a description is given of a method for producing a compressed wood article 1.

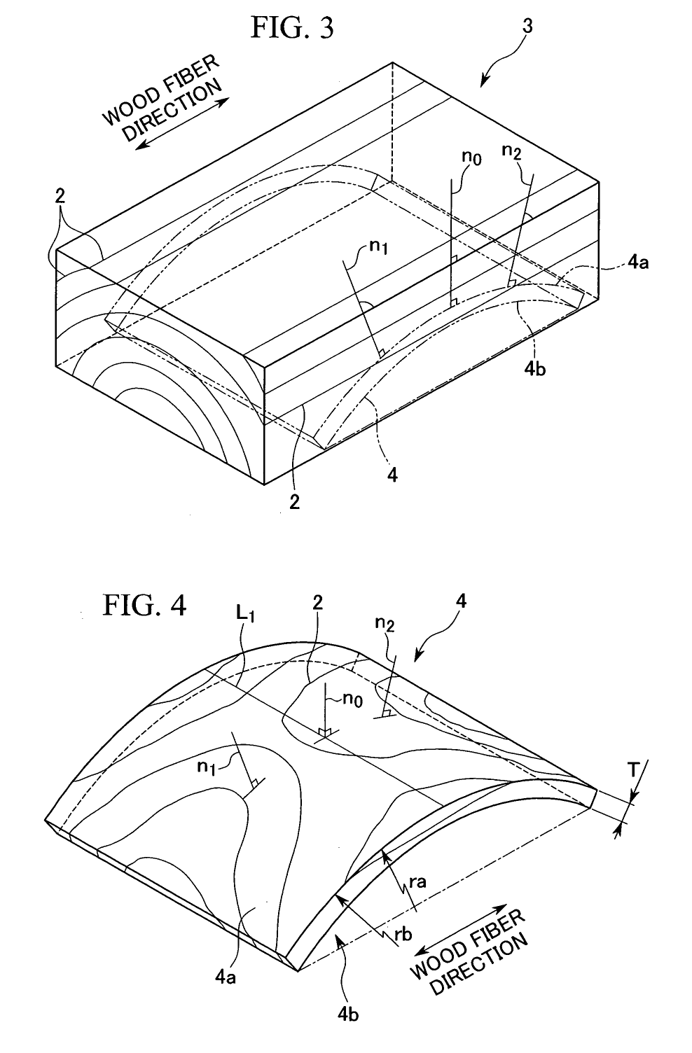

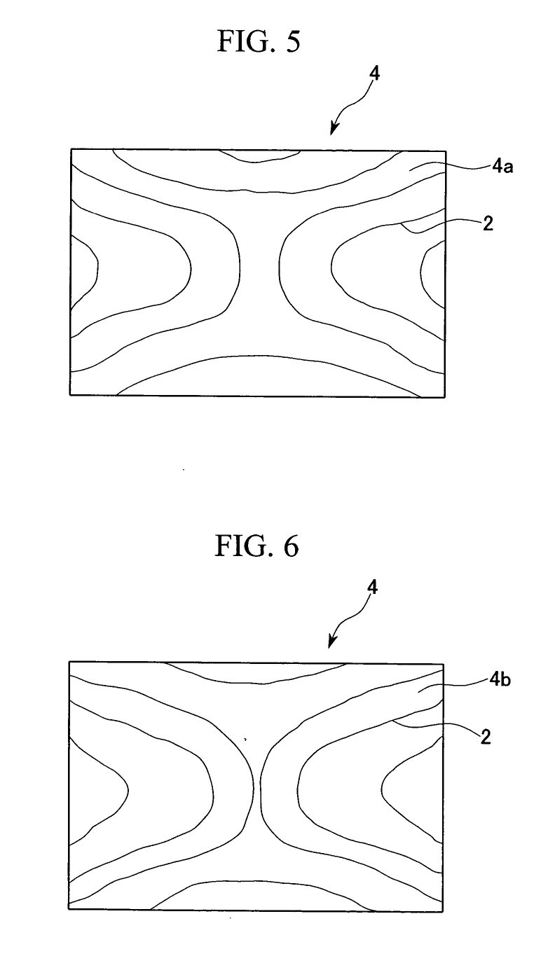

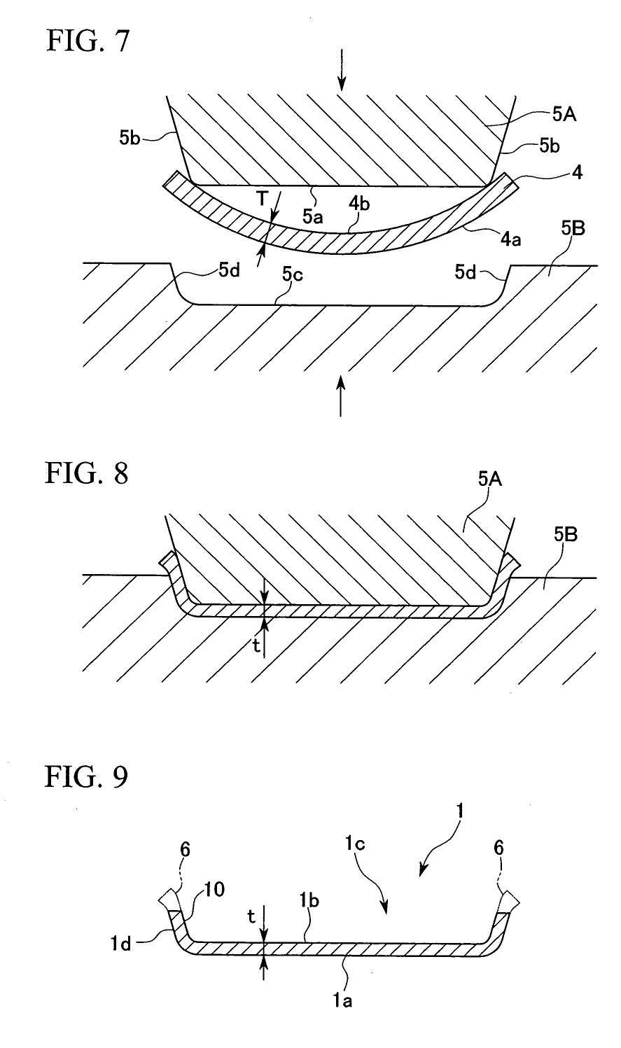

FIG. 3 is a perspective view of a base material for the compressed wood article 1. FIG. 4 is a perspective view of a blank member cut out from the base material shown in FIG. 3. FIG. 5 is a plan view depicting the blank member when being observed from the front side. FIG. 6 is a plan view depicting the blank member when being observed from the rear side. FIG. 7 and FIG. 8 are sectional views depicting respective states in the step of compressing the blank member shown in FIG. 4. FIG. 9 is a sectional view depicting a compressed wood article taken out from the molding dies in a compressing step of the blank member shown in FIG. 4. All of the sections depicted in FIG. 7 through FIG. 9 correspond to the sections taken along the line A-A shown in FIG. 1.

The method for producing the compressed wood article 1 according to the embodiment includes at least a step of forming a blank member and a step of compressing the same.

The blank member forming step is a step of cutting out, from a wooden base material 3, a plate-shaped blank member 4 to produce the compressed wood article 1, as depicted in FIG. 3 and FIG. 4. The base material 3 is, for example, a block-shaped cross grain board having a slightly larger area than that of the developed shape of the compressed wood article 1, as depicted in FIG. 3.

As regards the material for the base material 3, the type of wood is not especially limited as long as it is a compressible wood. For example, hinoki (Japanese cypress), hiba (taujopsis dolabrate), paulownia wood, teak, mahogany, Japanese cedar, pine tree, cherry tree, bamboo, etc., may be preferably employed.

As depicted in FIG. 3 and FIG. 4, the blank member 4 is a plate member having an almost uniform thickness T (where, T>t) and is cut out in a shape having a curved surface projecting in the direction intersecting the wood fiber direction of the base material 3. Also, the curved surface may be formed on a part of the blank member 4 or may be formed on the entirety thereof. The blank member 4 according to the embodiment is curved over its entirety. The section almost orthogonal to the wood fiber direction of the blank member 4 linearly extends in the direction crossing the annual rings. On the other hand, the section along the wood fiber direction is curved so that it projects from the center of the annual rings toward the outside thereof in the vicinity of the middle of the blank member. That is, the section along the wood fiber direction is curved to be like a circular arc.

In the blank member 4, it is assumed that the convex curved surface is regarded as an outside curved surface 4a and the concave curved surface is regarded as an inside curved surface 4b. The outside curved surface 4a forms the outer surface 1a of the bottom portion after being compressed, and the inside curved surface 4b forms the inner surface 1b of the bottom portion after being compressed. The radius of curvature of the outside curved surface 4a is rₐ, and the radius of curvature of the inside curved surface 4b is r_{b}(where, rₐ>r_{b}). In addition, although it is not necessary that rₐ and r_{b} be constant, it is required that the projecting amount be greater than the width of the annual rings. Also, the radii of curvature rₐ and r_{b} differ from the radius of curvature Rₐ of the outer surface 1a of the bottom portion and the radius of curvature R_{b} of the inner surface 1b of the bottom portion.

The normal line of the outside curved surface 4a and the normal line of the inside curved surface 4b are oriented in different directions at different positions like, for example, in normal lines n₀, n₁, n₂, etc. In the embodiment, as depicted in FIG. 4, the normal line n₀ in an area L₁ on the straight line extending in the width direction of the blank member 4 at the top of the outside curved surface 4a is orthogonal to the direction along which wood fibers extend, and the normal lines in the areas other than the above area obliquely intersect the wood fiber direction like, for example, in the normal lines n₁ and n₂.

Where, as in the blank member 4 according to the embodiment, the section almost orthogonal to the wood fiber direction linearly extends, and the section along the wood fiber direction curves so as to be like a circular arc, it is possible to cut out the blank member 4 from the base material 3 using a tool for straightly cutting off an object such as, for example, a wire cutter, etc. Therefore, in comparison with a case where the blank member 4 has an intricate shape and it is necessary to three-dimensionally cut out the blank member from the base material, there is an advantage in that the cutting work can be more easily facilitated. Furthermore, since another blank member 4 can be cut out from the adjacent area of the base material 3, there is another advantage in that the utilization efficiency of the base material 3 is high.

If the cutting is carried out as described above, the curved surface is formed so as to intersect the wood fibers except in the area L₁ where the normal lines of the curved surface are orthogonal to the wood fiber direction. Furthermore, as depicted in FIG. 5 and FIG. 6, a plurality of grain lines 2 are exposed on the outside curved surface 4a and the inside curved surface 4b. The grain lines 2 are a group of U-shaped curved lines which open toward respective four sides of the blank member 4.

Generally, wood fibers extending in the growing direction of wood are formed while increasing the quantity thereof in line with its growth. Since the distribution of wood fibers is made dense or coarse depending on the seasons in which the wood grows, annual rings are formed inside the wood. Accordingly, if the wood is cut in the direction crossing the wood fiber direction, portions having high fiber density and portions having low fiber density alternately appear on the cut out section, wherein high density portions deep in color form grain lines.

That is, if wood is cut in the direction intersecting the wood fiber direction, concentrically circular or elliptical grain lines, or a part thereof appear on the cut surface. Also, if wood is cut in parallel to the wood fiber direction, almost parallel grains lines or U-shaped grain lines appear on the cut surface. In addition, curved grain lines appear in the vicinity of knots where branches are bifurcated.

However, according to a prior art producing method in which a cross-grained material or straight-grained material, sawed from a tall tree, like that used for building materials is used as a base material, when a plate-like and small-sized blank member having a size of, for example, 100 mm wide and 200 mm long or less is cut out, only a blank member in which the grain lines are distributed to be almost parallel to each other can be cut out even if the base material is a cross-grained material.

On the contrary, since the blank member 4 according to the embodiment is cut out so as to present a shape having a curved surface intersecting the wood fibers, diversified grain lines 2 are exposed on the surface, in contrast to a case where the base material 3 is cut in a plane, wherein changes may be caused in the grain lines 2 by varying the amount or the direction of the curvature of the blank member 4.

As depicted in FIG. 7 and FIG. 8, in the compressing step, the blank member 4 is compressed and formed using an upper molding die 5A and a lower molding die 5B, wherein the three-dimensional shape of the die surface is transferred onto the blank member 4, and a compressed wood article 1 is formed.

The upper molding die 5A is a core molding die for forming the inner surface of the compressed wood article 1, and is composed of a bottom die surface 5a for forming the inner surface 1b of the bottom portion and a side die surface 5b for forming the inner surface 1e of the side portion. In the embodiment, the bottom die surface 5a is a flat plane. The lower molding die 5B is a cavity molding die for forming the outer surface of the compressed wood article 1, and is composed of a bottom die surface 5c for forming the outer surface 1a of the bottom portion and a side die surface 5d for forming the outer surface 1d of the side portion. In the embodiment, the bottom die surface 5c is a flat plane.

In the present step, as depicted in FIG. 7, the blank member 4 is set between the upper molding die 5A and the lower molding die 5B so that the inside curved surface 4b faces the upper molding die 5A and the outside curved surface 4a faces the lower molding die 5B.

Moreover, by causing the upper molding die 5A and the lower molding die 5B to slide in the vertical direction and to approach each other, the blank member 4 is compressed in the vertical direction. At this time, water vapor at high temperature of, for example, 120° C. through 200° C. and high pressure is injected onto the blank member 4 in order to soften the blank member 4, whereby the blank member 4 is deformed, following the molding die surface, and the curved surface is pressed onto the die surface and is closely adhered thereto without any clearance. After the blank member 4 has been compressed until the thickness is reduced from T to t, the upper molding die 5A and the lower molding die 5B are stopped.

In the compressing step described above, to soften the blank member 4, the blank member 4 may be boiled in hot water at a temperature of 40° C. or more for a predetermined period of time, and thereafter the blank member 4 may be compressed in an atmosphere at high temperature of 120° C. through 200° C. and high pressure. Also, it is preferable that the upper molding die 5A and the lower molding die 5B be heated to a temperature equivalent thereto. Furthermore, if compression is carried out with the upper molding die 5A and the lower molding die 5B installed in a highly-pressurized container, efficient compression may be carried out.

Next, as depicted in FIG. 8, the dies are kept clamped until the shape of the die surface is transferred onto the blank member 4 and fixed thereon. Furthermore, the clamped state is maintained for a predetermined period of time. Then, the blank member 4 is dried up and is released from the molding dies.

After being released from the molding dies, portions 6 to be removed (portions depicted by virtual lines in FIG. 9), which correspond to, for example, the ends at the side portions, are removed as necessary to complete the shape.

It is how the compressed wood article 1 is produced.

According to the method for producing a compressed wood article 1 described above, diversified grain lines 2, which cannot be obtained by cutting out the blank member from the base material 3 in a plane, can be exposed on the surface of the compressed wood article 1 by varying the amount or the direction of the curvature of the blank member 4. Therefore, it is possible to produce a member having an appearance excellent in design.

In particular, according to the method for producing the compressed wood article 1 as described above, even if a completed article is small-sized, it is possible to expose diversified grain lines 2 on the surface of the compressed wood article 1.

The amount of curvature of the curved surface formed on the blank member 4 may be adequately adjusted in order to apply variations in the shape of the grain lines 2. Therefore, a description is given of a first modification of the blank member according to the embodiment.

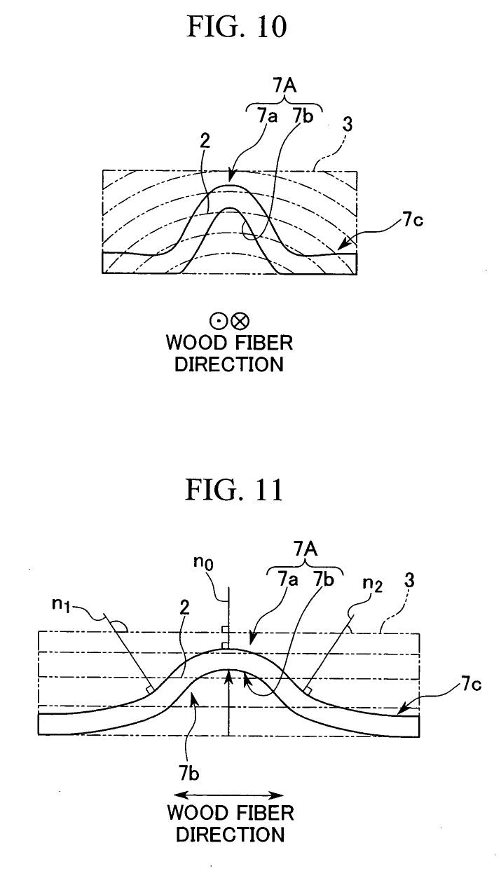

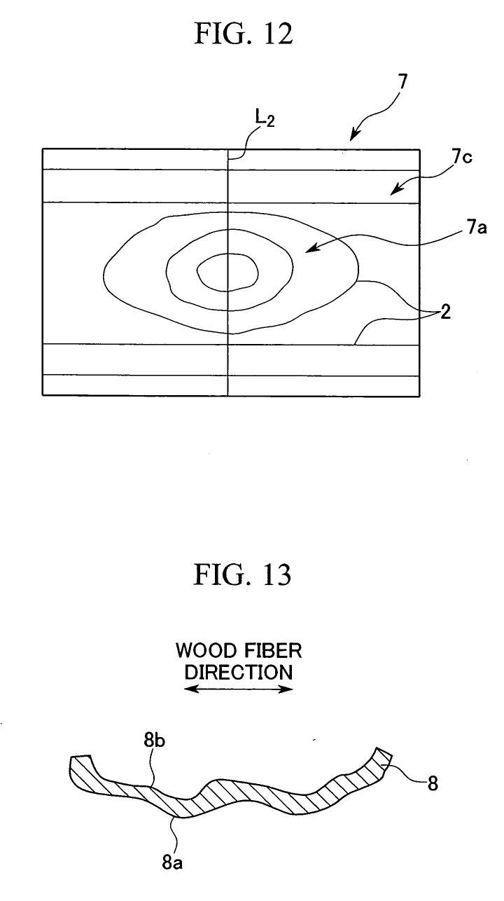

FIG. 10 is a sectional view depicting a blank member according to the first modification of the embodiment when being observed in the wood fiber direction. FIG. 11 is a sectional view depicting the blank member according to the first modification when being observed in the direction orthogonal to the wood fiber direction. FIG. 12 is a plan view depicting the blank member according to the first modification when being observed from above.

Also, in FIG. 10 and FIG. 11, the size of the curved portion is exaggerated for easier understanding of the description, and the blank member 7 is schematically depicted, wherein, for example, the relationship between the plate thickness and the width of the annual rings is not based on accurate dimensions.

In the blank member 7 according to the first modification, a curved surface is formed so that concentrically elliptical grain lines are exposed at a predetermined position. As depicted in FIG. 10 and FIG. 11, in the blank member 7 cut out from the base material 3, a curved portion 7A consisting of an outside curved surface 7a and an inside curved surface 7b is provided at the middle of an almost rectangular plane portion 7c. The curved portion 7A is projected like a dome in the radial direction of the annual rings, that is, in the direction almost orthogonal to the wood fibers.

As depicted in FIG. 11, the normal line of the outside curved surface 7a and the normal line of the inside curved surface 7b are oriented in different directions at different positions like, for example, in the normal lines n₀, n₁, n₂, etc. In the embodiment, although the normal line n₀ in an area L₂ (refer to FIG. 12) on the straight line extending in the width direction of the blank member 7 at the top of the outside curved surface 7a is orthogonal to the direction along which wood fibers extend, the normal lines in the area other than the above area, for example, the normal lines n₁ and n₂, obliquely intersect the wood fiber direction.

Since the curved portion 7A intersects the grain lines 2 equivalent to, for example, three annual rings of the base material 3 on the outside curved surface 7a, concentrically elliptical grain lines 2 are formed in triplicate at the middle portion of the blank member 7 having the curved portion 7A formed therein as depicted in FIG. 12.

Where no curved portion 7A is provided, as is easily understood in FIG. 10 and FIG. 11, no grain line 2 appears at the middle portion of the blank member 7, and only almost parallel grain lines 2 are formed at both sides, whereby only a remarkably simple grain pattern appears.

If such a blank member 7 is compressed and formed using the upper molding die 5A and the lower molding die 5B, concentrically elliptical grain lines 2 similar to those in FIG. 12 are formed on the outer surface of the bottom portion.

According to the modification, it is possible to vary the number of concentric ellipses by changing the projecting height of the curved portion 7A. In addition, by inclining the projecting direction of the curved portion 7A in a direction other than 90° from the wood fiber direction, it is possible to change a shape of concentric ellipses to, for example, a grain pattern composed of a group of more intricate closed curves, which are distorted ellipses such as, for example, ovals.

Next, a description is given of a second modification of the embodiment.

FIG. 13 is a sectional view depicting a blank member 8 according to the second modification when being observed in the direction orthogonal to the wood fiber direction.

The blank member 8 according to the second modification is a plate-shaped member having a plurality of curved portions as depicted in FIG. 13. The blank member 8 has an outside curved surface 8a and an inside curved surface 8b. It is also possible to form a further intricate grain pattern by varying the projecting height, projecting direction and curvature of the respective curved portions.

The blank member 8 may be like a corrugated sheet, the sectional shape of which does not change in the depth direction of FIG. 13, or may be a three-dimensional shape curved in the depth direction in FIG. 13. In the former case, the blank member 8 may be cut out by, for example, a wire cutter, etc.

Since the blank member 8 described above is provided with a plurality of curved portions, the shape of the grain lines 2 may be freely deformed and may be rippled minutely.

It is preferable that such a plurality of curved portions are smoothly connected to each other. In this case, it is possible that acute-angled bending differing from a natural grain pattern, for example, a serrated pattern does not appear on the grain lines 2. Therefore, the impressions are not brought about that the deformed grain lines are unnatural or artificial. Rather, it is possible to form grain lines imitating a grain pattern sampled from an old deformed tree, etc.

In addition, the above description is based on an example in which the blank member has an almost uniform thickness T. Where the thickness t of the compressed wood article 1 changes according to positions, or where the compression ratio may be uneven to some degree, the thickness T may be changed according to positions.

According to the embodiments, since a plate-shaped blank member having a curved surface intersecting its thickness direction, in which the curved surface has a portion whose normal lines are not orthogonal to the direction in which the wood fibers extend, is cut out from a raw wood. The wood fibers are therefore cut off at the portion of the blank member whose normal lines are not orthogonal to the direction in which the wood fibers extend, and are exposed on the surface. Therefore, curved grain lines intersecting the annual rings of wood, for example, diversified grain lines having a group of U-shaped curves and a group of concentric closed curves are exposed on the surface of the blank member. As a result, it is possible to cause such diversified grain lines to be exposed at specified portions of the surface after compression.

According to the embodiments, since the portion which is included in the curved surface, and whose normal lines are not orthogonal to the direction in which the wood fibers extend, is compressed by the die surface whose curvature differs from that of the portion, it is possible to form grain lines that cannot be obtained in a case where the curvature of the curved surface of a blank member is equal to the curvature of the die surface. For example, where the die surface is flat, or the curvature of the curved surface is small, the grain lines are apt to take on a simple or predictable pattern. Even in such portions, it is possible to form diversified grain lines.

The wood fiber direction of the wood refers to a direction in which a tree grows, and where the center of the annual rings extends.

A pattern of grain lines exposed on the surface of a compressed wood article according to the embodiments is different from that of a compressed wood article obtained by compressing a flat-shaped blank member or a blank member which is cut out in a three-dimensional shape following molding dies. Therefore, it is possible to form a diversified grain pattern.

In a compressed wood article having such grain lines, at least a part of the grain lines are exposed as a cut-out section of wood fibers, and the wood fibers that form such grain lines are curved at a curvature different from that of the surface.

Also, exposure of the grain lines means that they can be seen. For example, a transparent or semi-transparent coating layer may be provided on the surface.

In a method for producing a compressed wood article according to the embodiments and a compressed wood article thereby produced, since a plate-shaped blank member having a curved surface intersecting the thickness direction, in which the curved surface has a portion whose normal lines are not orthogonal to the direction in which wood fibers extend, the wood fibers are cut off at the portion of the blank member whose normal lines are not orthogonal to the direction in which the wood fibers extend, and are exposed on the surface. Therefore, it is possible to cause diversified grain lines to be exposed on the surface in response to the curved shape of the blank member, and it is possible to provide a compressed wood article having an excellent appearance.

While a preferred embodiment of the invention has been described and illustrated above, it should be understood that this is an exemplary example of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

The present invention is suitable for manufacturing wooden structures having various shapes such as, for example, a plate material, a box, a container, a covering member, etc., using a compressed wood article formed by molding dies.

What is claimed is:

1. A method for producing a compressed wood article, comprising the steps of:
cutting out, from a raw wood, a plate-shaped blank member having a curved surface intersecting its thickness direction, in which said curved surface has a portion whose normal lines are not orthogonal to a direction in which wood fibers extend; and
compressing said blank member using molding dies.

2. The method for producing a compressed wood article according to claim 1, wherein the curvature of said portion which is included in said curved surface, differs from the curvature of a die surface of said molding dies corresponding to said portion.

3. A compressed wood article cut out from a raw wood and having grain lines exposed on the flat or curved surface thereof, which is cut out from said raw wood in a shape that has a curvature different from a curvature of said flat or curved surface and has a curved surface including a portion whose normal lines are not orthogonal to the direction in which wood fibers extend, said curved surface being formed to form said flat or curved surface by being compressed, whereby grain lines formed on said curved surface are exposed on said flat or curved surface.
